(19) United States
(12) Patent Application Publication
(10) Pub. No.: US 2013/0260019 A1
(43) Pub. Date: Oct. 3, 2013

(54) LAYER-ON-LAYER COATING DEVICE AND DOUBLE-SIDED COATING DEVICE, METHOD FOR PRODUCING ELECTRODE PLATES, AND METHOD FOR PRODUCING BATTERIES

(71) Applicant: Yutaka Sugie, Toyota-shi (JP)

(72) Inventor: Yutaka Sugie, Toyota-shi (JP)

(21) Appl. No.: 13/990,046

(22) PCT Filed: Nov. 30, 2010
(86) PCT No.: PCT/JP2010/071365

§ 371 Date: May 29, 2013

(51) Int. Cl. H01M 4/04

(52) U.S. Cl. CPC H01M 4/0402
USPC 427/58; 118/68

(57) ABSTRACT

The layer-on-layer coating device of an embodiment of the invention that conveys band-shaped substrates in the longitudinal direction thereof and coats two kinds of coating materials successively on the substrate comprises: a first coating unit that coats a first coating material on one surface of the substrate; a second coating unit that coats, without drying the first coated material in a drying furnace, a second coating material by a contactless method on the first coating material coated on the one surface by the first coating unit; and a feed roller that is disposed on the downstream side, in the direction of substrate conveyance, of the second coating unit and is driven by a driving source. It is thereby possible to apply a stable tension on the substrate while stably coating two layers of coating materials layer-on-layer using respective coating units and to produce electrode plates and batteries of stable properties.

### TECHNICAL FIELD

The present invention relates to a layer-on-layer coating device to firstly apply a coating material of a first layer on a base sheet and to successively apply a coating material of a second layer thereon, and a method for producing an electrode plate by use of the coating device. More specifically, the present invention relates to a layer-on-layer coating device, a double-side coating device, an electrode plate producing method, and a battery producing method in which second layer coating is performed without drying the coating material of the first layer by using a drying furnace or the like.

### BACKGROUND ART

Conventionally, in lithium ion secondary batteries, for example, there have been widely used electrode plates in each of which a strip-shaped base sheet (a substrate) made of aluminum foil, copper foil, or the like is formed with an electrode active material layer. This electrode active material layer is made through processes such as coating, drying, and pressing. The kinds of coating materials to be coated are different between a positive electrode plate and a negative electrode plate. For positive electrode, for example, a mixture of conductive material and binder with lithium salt is generally used. For negative electrode, for example, a mixture of a thickening agent and binder with carbon-based material is generally used.

As a coating device for applying a coating material to a strip-shaped base sheet, for example, there is a die coating unit. This die coating unit is configured to convey a base sheet by winding the base sheet around a backup roll and to coat the base sheet in non-contact manner (e.g., see Patent Document 1). The die coating unit discharges coating material toward the base sheet through a slit of a coater placed facing the backup roll. The coater of the die coating unit is disposed in non-contact with the base sheet. The die coating unit is adapted to adjust the coating thickness based on an amount of the coating material to be discharged from the coater and a traveling speed of the base sheet. The device disclosed in this Patent Document I further includes a decompression unit located upstream of a portion of the base sheet to be coated to reduce the pressure in the space on a coated side of the base sheet.

As another coating device to apply coating material to a strip-shaped base sheet, there is a gravure coating unit, for example. This gravure coating unit is configured to make a base sheet contact with a gravure roll, on a surface of which coating material is adhered, and to transfer the coating material onto the base sheet (e.g., see Patent Document 2). The gravure roll of the gravure coating unit is normally rotated in a reversed direction to a traveling direction of the base sheet at contact points of the gravure roll and the base sheet. On the other hand, the base sheet is conveyed by a roller and others provided separately from the gravure roll.

In manufacture of electrode plates, recently, a technique that uses two kinds of coating materials which are successively applied to form an electrode active material layer has been developed. According to this technique, for example, a coating material containing much binder is firstly applied to a base sheet and then a coating material different therefrom is applied thereon. This technique is different from conventional coating in which all coating materials are mixed and simultaneously applied to a base sheet. The coating of the second layer is performed without drying the first coated layer so that those materials are mixed to some extent after the coating process. Therefore, there is proposed a system in which the gravure coating unit and the die coating unit are disposed in adjacent positions wherein a base sheet having undergone gravure coating is directly subjected to die coating,

### RELATED ART DOCUMENTS

### Patent Documents

Patent Document 1: JP-A-2006-156232

Patent Document 2: JP-A-2009-218053

### SUMMARY OF INVENTION

### Problems to be Solved by the Invention

However, in the case of forming two continuous coating layers by using the aforementioned two coating devices in combination, the following problems occur. After the first coating layer is formed, the coating material is still wet and it is thus hard to nip and hold the base sheet by a roller or the like. Therefore, a device for controlling the tension of the base sheet could not be placed between the coating devices for the first layer and for the second layer. However, the tension of the base sheet is a factor that influences coating quality. Specifically, when the tension of the base sheet is unstable, the coating quality is not stable, resulting in non-uniform quality.

In particular, when the gravure coating unit is used as the coating device for the first layer, the base sheet is placed in contact with the gravure roll rotating in the reverse direction to the traveling direction of the base sheet. At their contact points, the base sheet receives frictional force from the gravure roll. Accordingly, the tension of the base sheet is made different between the front and back of the gravure coating unit. The magnitude of the frictional force varies according to various factors such as viscosity of the coating material adhered to the gravure roll. The tension of the base sheet after gravure coating is thus unstable.

When the die coating unit disclosed in Patent Document 1 is used as the coating device for the second layer, the decompression device is placed upstream of the portion of the base sheet to be coated. Suction force of this decompression device acts as resistance against traveling of the base sheet. That is, the base sheet receives the force acting in a direction defying the traveling. Furthermore, the backup roll of the die coating unit usually has a relatively large diameter to ensure the accuracy of coating thickness. This may cause the base sheet to float from the backup roll and slip on the backup roll. Due to the above causes such as the presence of the decompression device and the diameter of the backup roll, the die coating unit has a problem that the tension of the base sheet is not stable.

The present invention has been made to solve the above problems of the conventional coating devices. Specifically, the present invention has a purpose to provide a layer-on-layer coating device arranged to successively form two layers of coating materials by respective corresponding coating devices and to enable stable coating of each layer while applying stable tension to a base sheet, and a double-side coating device, an electrode plate producing method, and a battery producing method.

### Means of Solving the Problems

To achieve the above purpose, one aspect of the invention provides a layer-on-layer coating device arranged to convey a strip-shaped base sheet in its longitudinal direction and apply two kinds of coating materials in layers to the base sheet, the device comprising: a first coating unit to apply first coating material to one surface of the base sheet; a second coating unit to apply second coating material in non-contact manner onto the first coating material coated on the one surface of the base sheet by the first coating unit without drying the first coated material by use of a drying furnace, and a feed roller placed downstream of the second coating unit in a conveying direction of the base sheet, the feed roller being driven by a drive source.

According to the layer-on-layer coating device of the above configuration, the first coating material is coated on the one surface of the base sheet by the first coating unit. The second coating material is then coated on the first coated material by the second coating unit. Since the above configuration further includes the feed roller, the base sheet is conveyed by the feed roller on a downstream side of the second coating unit. Accordingly, the stable tension can be applied to the base sheet and each layer can be coated stably.

In the above configuration, preferably, the second coating unit includes a backup roll placed to face a coater of the second coating material, the feed roller has a smaller diameter than the backup roll, and a winding angle of the base sheet on the feed roller is larger than a winding angle of the base sheet on the backup roll. According to this configuration, the device can reliably convey the base sheet by use of the feed roller without increasing the size of the device.

In the above configuration, further preferably, the feed roller is formed, on its outer peripheral surface, with a plurality of grooves in a circumferential direction or with a spiral groove obliquely extending so that a facing position to the base sheet moves from inner toward outer in the axial direction as the rod is rotated. According to this configuration, it is possible to release air through the grooves to prevent the air from entering between the feed roller and a part of the base sheet wound on the feed roller and causing floating of the base sheet. Thus, the conveying state of the base sheet by the feed roller can be made more reliable.

Furthermore, it is preferable in the above configuration that the feed roller has an outer peripheral surface with surface roughness higher than surface roughness of an outer peripheral surface of the backup roll. According to this configuration, the feed roller and the base sheet are less likely to slip on each other. Thus, the conveying state of the base sheet by the feed roller can be made more reliable.

Another aspect of the invention provides a double-side coating device including two layer-on-layer coating devices according to one of claims 1 to 4, the double-side coating device being arranged to apply coating materials on each of surfaces of a strip-shaped base sheet in sequence to apply the coating materials to both of the surfaces of the base sheet, wherein the double-side coating device comprises a drying device placed between the two layer-on-layer coating devices, and the feed roller included in the layer-on-layer coating device to be used first has a smaller diameter than a diameter of the feed roller included in the layer-on-layer coating device to be used later.

According to this configuration, the first and second coating materials are applied in layers on one surface of the base sheet by the layer-on-layer coating device used first. The coated base sheet subsequently passes through the drying device such as a drying furnace to dry the coated coating materials. In addition, the first and second coating materials are also applied in layers on the other surface of the base sheet by the layer-on-layer coating device used later. The surface of the base sheet that will contact with the feed roller used first is a surface being not yet coated. The surface of the base sheet that will contact with the feed roller used later is a surface of the coated layer having been subjected to the drying process after the coating process. In the above configuration, the feed roller of the layer-on-layer coating device used first has a smaller diameter than that of the feed roller of the layer-on-layer coating device used later. Thus, the surface of the base sheet before being coated can also be surely fed forward.

Furthermore, another aspect of the invention provides a method for producing an electrode plate by conveying a strip-shaped base sheet in its longitudinal direction and applying two kinds of coating materials to the base sheet to form electrode active material layers, the method including: applying first coating material containing binder to one surface of the base sheet; applying second coating material containing electrode active material with a lower content of binder than that in the first coating material, in noncontact relation to the first coating material coated on the one surface of the base sheet without drying the first coated material by a drying furnace, and conveying the base sheet by holding a back surface of a portion of the base sheet coated with the first and second coating materials in contact with the feed roller driven by a drive source.

In this configuration, on the strip-shaped base sheet, the first coating material containing the binder and the second coating material containing the electrode active material with a lower content of binder than that in the first coating material are coated layer-on-layer. The coated base sheet is conveyed by the feed roller. Since a stable coated state can be achieved as above, an electrode plate having stable performance can be produced. It is to be noted that the second coating material is coated on top of the first coated material. The coating device for the second coating material is placed more downstream than the coating device for the first coating material in a conveying direction of the base sheet. The feed roller serves to convey the base sheet by contacting with the back surface coated with the first and second coating materials. This feed roller is therefore disposed more downstream than the coating device for the second coating material in the base sheet conveying direction.

Another aspect of the present invention provides a method for producing a battery by using an electrode plate produced in such a manner that electrode active material layers are formed on both surfaces of a strip-shaped base sheet, the method includes: applying first coating material containing binder to one surface of the base sheet; applying second coating material containing electrode active material with a lower content of binder than that in the first coating material, in noncontact relation to the first coating material coated on the one surface of the base sheet without drying the first coated material by a drying furnace; conveying the base sheet by making a back surface of a portion of the base sheet coated with the first and second coating materials by the first feed roller driven by a drive source; drying the base sheet on which the first and second coating materials are coated; applying first coating material containing binder to the other surface of the base sheet; applying second coating material containing electrode active material with a lower content of binder than that in the first coating material, in noncontact relation to the first coating material coated on the other surface of the base sheet without drying the first coated material by a drying furnace; conveying the base sheet by making a back surface of a portion of the base sheet coated with the first and second coating materials by a second feed roller driven by a drive source; and drying the base sheet on which the first and second coating materials are coated, the first feed roller having a smaller diameter than that of the second feed roller.

In this configuration, on each of both surfaces of the strip-shaped base sheet, the first coating material containing the binder and the second coating material containing the electrode active material with a lower content of binder than in the first coating material are coated layer-on-layer. During coating on each of the surfaces, the base sheet is conveyed by the feed roller and thus in a stable coating state. Consequently, a battery having stable performance can be produced.

### Effects of the Invention

According to the layer-on-layer coating device and double-side coating device, the electrode plate producing method, and the battery producing method in the above configurations of the invention, using the coating devices for successively forming two layers of coating materials, it is possible to stably form the layers respectively while applying stable tension thereon.

### BRIEF DESCRIPTION OF THE DRAWINGS

FIG. 1 is a schematic configuration view of a coating device in an embodiment;

FIG. 2 is an explanatory view showing a double-side coating device in the embodiment;

FIG. 3 is a perspective view showing a first feed roller;

FIG. 4 is a perspective view showing a second feed roller; and

FIG. 5 is a graph showing a relationship between conveying speed and air-floating amount.

### MODE FOR CARRYING OUT THE INVENTION

A detailed description of a preferred embodiment of the present invention will now be given referring to the accompanying drawings. In the present embodiment, the invention is applied to a method for producing a lithium ion secondary battery and a coating device to be used to produce an electrode plate.

The producing method of the lithium ion secondary battery in the present embodiment is schematically conducted by the following steps.
(1) Electrode active material layer are formed on metal foils to produce a positive electrode plate and a negative electrode plate, respectively.
(2) The electrode plates produced in (1) and separators are laminated and wound together to produce a wound body.
(3) The wound body is connected to a positive electrode terminal and to a negative electrode terminal.
(4) The wound body is inserted in a battery case and an electrolyte is poured into the battery case.
(5) A liquid pouring port is closed to seal the inside of the battery case.
(6) Initial charging process is performed,

The present invention is characterized in the electrode plate producing process in the above step (1). The steps (2) to (6) excepting the step (1) are the same as conventional steps and thus their explanations are omitted herein. The electrode plate producing process in the step (1) in the present embodiment is a process for forming an active material layer on each of both surfaces of a metal foil to be used as a collector foil of the electrode plate. In the present embodiment, the coating material for forming the active material layer is classified into first coating material mainly containing binder and second coating material containing material other than the binder. The coating device in the present embodiment is configured to successively apply two kinds of coating materials to the base sheet.

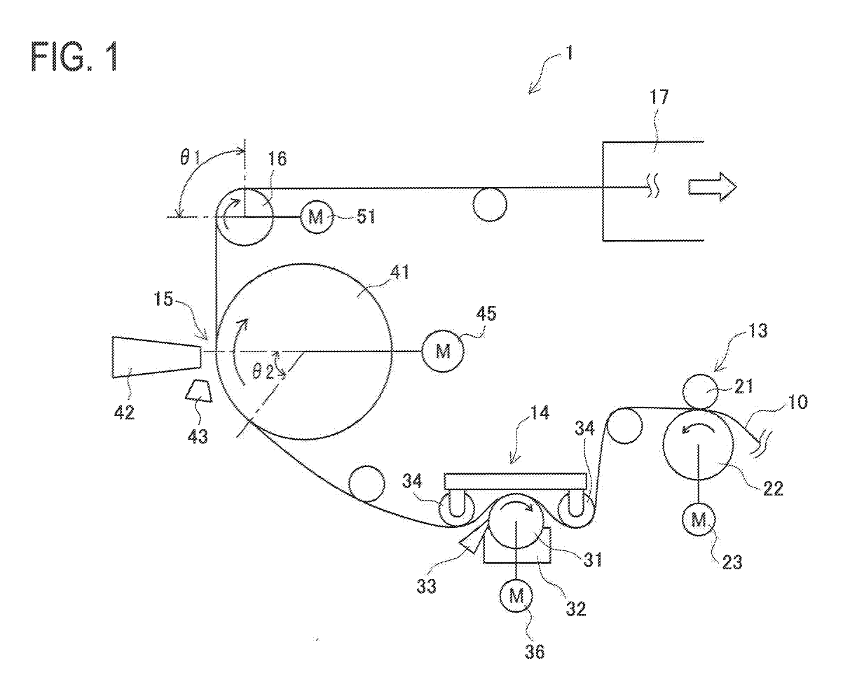

In coating treatment in the present embodiment, a layer-on-layer coating device 1 shown in FIG. 1 is used. This device 1 is arranged to apply the two kinds of coating materials in layers to a base sheet. The layer-on-layer coating device 1 includes, in the order from lower right in the figure in a traveling direction of the base sheet 10, a set of nip rollers 13, a gravure coating unit 14, a die coating unit 15, and a feed roller 16. In an area between the gravure coating unit 14 and the die coating unit 15, any other treatment process is not performed, so that continuous treatments are conducted. Ahead of this wet-on-wet coating device 1, furthermore, a drying device 17 is provided to dry the coated materials.

The nip rollers 13 include two rollers 21 and 22 to feed forward the base sheet 10 as shown in FIG. 1. The base sheet 10 is applied, at this site, with appropriate tension and speed. The roller 22 of the nip rollers 13 is driven and controlled by a motor 23. The roller 22 is rotated to move in the same direction at a point contacting with the base sheet 10 as a conveying direction of the base sheet 10 as indicated by an arrow in the figure.

The gravure coating unit 14 is configured to apply the first coating material to the base sheet 10, i.e., to form a binder layer. This coating unit 14 includes a gravure roll 31, a liquid bath 32, a blade 33, and a pressing member 34 as shown in FIG. 1. The gravure roll 31 can hold a predetermined amount of coating material according to engraved marks or the like provided on a part of its outer peripheral surface. This gravure roll 31 is partially dipped in the liquid bath 32 and driven and controlled by a motor 36. The gravure roll 31 is rotated to move in a reverse direction at a point contacting with the base sheet 10 to the traveling direction of the base sheet 10 as indicated by an arrow in the figure.

The liquid bath 32 is used to store the coating material therein. The blade 33 is arranged to scrape away excess coating material adhered to the gravure roll 31. Thus, a tip end of the blade 33 is pressed against the outer surface of the gravure roll 31. The pressing member 34 includes two rollers arranged at separate positions to contact with the back surface of the base sheet 10. The pressing member 34 presses a part of the base sheet 10 against the gravure roll 31 between the two rollers. These rollers of the pressing member 34 are not rotarily driven.

The die coating unit 15 is arranged to apply coating material for a second layer to the base sheet 10, that is, coating material other than the binder. This second-layer coating material may contain binder but at a lower rate than in the first layer. The die coating unit 15 includes a backup roll 41, a coater 42, and a decompression device 43 as shown in FIG. 1. The backup roll 41 is driven and controlled by a motor 45. The backup roll 41 is rotated to move in the same direction at a point contacting with the base sheet 10 as the traveling direction of the base sheet 10 as indicated by an arrow in the figure. The backup roll 41 is used to ensure the accuracy of coated film thickness and usually has a large diameter. In the present embodiment, for example, the backup roll 41 is a roll having a diameter of 250 mm.

The coater 42 is placed to face the backup roll 41. The coater 42 is used to discharge coating material toward the base sheet 10. Based on an amount of the coating material to be discharged from the coater 42 and circumferential velocity of the backup roll 41, a coating amount of the coating material to the base sheet is controlled. The decompression device 43 is a device for reducing the pressure in the space between the coater 42 and the coated surface of the base sheet 10. This pressure-reduction in this space enables the coating material discharged from the coater 42 to surely adhere to the base sheet 10.

The feed roller 16 is a roller placed right behind the die coating unit 15 as shown in FIG. 1. This feed roller 16 is connected to a motor 51. The feed roller 16 is rotated in contact with the back surface of the base sheet 10. The feed roller 16 is a roller to convey the base sheet 10. The feed roller 16 is rotated to move in the same direction at a point contacting with the base sheet 10 as the traveling direction of the base sheet 10 as indicated by an arrow in the figure. The feed roller 16 has a remarkably smaller diameter than that of the backup roll 41 in the die coating unit 15. Furthermore, the winding angle θ1 of the base sheet 10 with respect to the feed roller 16 is larger than the winding angle θ2 of the base sheet 10 with respect to the backup roll 41.

A coating treatment using the above layer-on-layer coating device 1 will be explained below. As show in FIG. 1, the base sheet 10 is supplied from upstream of the nip rollers 13. The base sheet 10 is fed forward under appropriate tension and at appropriate speed adjusted by the nip rollers 13. Binder solution for a first layer is firstly applied to the base sheet 10 by the gravure coating unit 14.

According to the gravure coating unit 14 of the present embodiment, the binder solution in the liquid bath 32 is adhered to the gravure roil 31 by its rotation. The surface of the gravure roll 31 is scraped with the blade 33, thereby regulating an adhesion amount of the binder solution to a target amount. In this state, the base sheet 10 is rubbed against the gravure roll 31 by the pressing member 34 to form a binder layer as the first layer on the base sheet 10.

Subsequently, a second layer is formed of active material other than the binder by the die coating unit 15. In an area between the gravure coating unit 14 and the die coating unit 15, any roller driven by a motor and a drying device is not placed. In this area, only a driven roller to adjust the orientation of the base sheet 10 is placed.

In the present embodiment, including the feed roller 16 as shown in FIG. 1, the base sheet 10 can be surely fed by the feed roller 16. In particular, since the winding angle θ1 is larger than the winding angle θ2, the feed roller 16 can surely convey even if the base sheet 10 is hard to be fed in a stable state by the backup roll 41. Furthermore, the feed roller 16 has a small diameter, so that the device 1 can be made compact without increasing in size. Thus, the tension and the traveling speed of the base sheet 10 on the backup roll 41 become stable and the coating thickness is obtained stably as intended by the die coating unit 15. By the coater 42, the coating material is applied as the second layer on the first layer.

As above, the base sheet 10 applied with the coating materials in two layers is fed into the drying device 17 as shown in FIG. 1. The coated materials are dried in the drying device 17. Then, through subsequent processes, a finished electrode plate is produced. Using this electrode plate, furthermore, a secondary battery is manufactured in the same processes as in a conventional manner. Since the active material layer is formed on the metal foil by the layer-on-layer coating device 1 of the present embodiment as above, an electrode plate having stable performance can be produced.

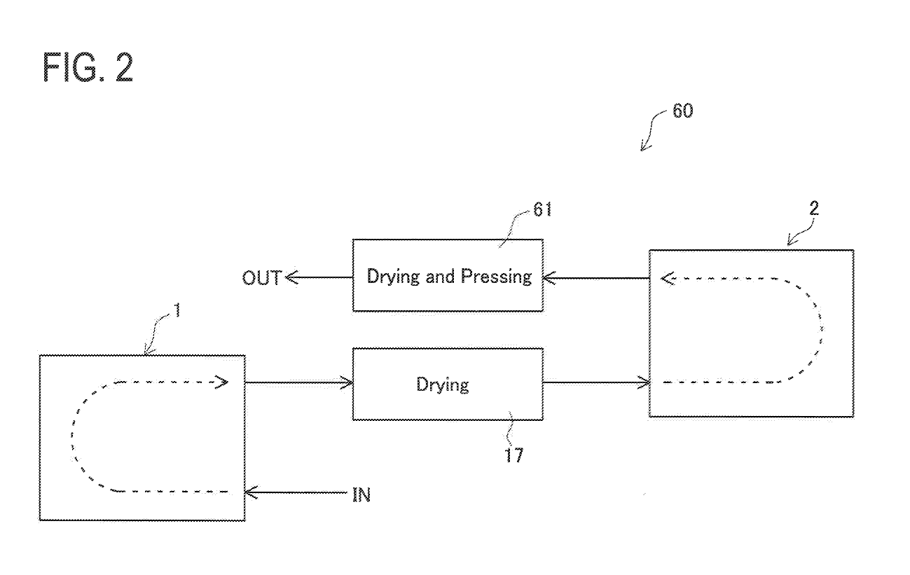

The layer-on-layer coating device 1 in FIG. 1 is arranged to apply the coating materials to one surface of the base sheet 10. The electrode plate producing process in the present embodiment is a step for forming an active material layer on each of both surfaces of the base sheet 10. In the present embodiment, therefore, a double-side coating device 60 shows in FIG. 2 is used. This double-side coating device 60 includes the layer-on-layer coating device 1, the drying device 17, a layer-on-layer coating device 2, and a drying-and-pressing device 61. The layer-on-layer coating device 1 is configured, as explained in FIG. 1, to coat a first surface of a metal foil. In the present embodiment, a pressing device may be placed additionally between the drying device 17 and the layer-on-layer coating device 2.

The layer-on-layer coating device 2 shown in FIG. 2 is arranged to apply coating materials to a second surface of the base sheet 10 on the first surface of which the active material layer is completed. This device 2 substantially has a laterally reversed configuration of the layer-on-layer coating device 1 shown in FIG. 1. The drying-and-pressing device 61 is arranged to dry and to press the base sheet 10 coated with the coating materials by the layer-on-layer coating devices 1 and 2. In the double-side coating device 60 in the present embodiment, the following four processes are performed sequentially in the following order: Coating treatment using the layer-on-layer coating device 1 to the first surface; Drying treatment using the drying device 17 located in a lower side in the figure to the coated materials on the first surface; Coating treatment using the layer-on-layer coating device 2 to the second surface; and Drying treatment using the drying-and-pressing device 61 located in an upper side in the figure to the coated materials on the second surface. Thus, an electrode plate formed, on both surfaces, with active material layers is completed.

In the layer-on-layer coating devices 1 and 2, the base sheet 10 to be put therein has a back surface in a different state. The base sheet to be put in the layer-on-layer coating device 1 is an uncoated metal foil. On the other hand, the base sheet to be put in the layer-on-layer coating device 2 is a one-side-coated foil having the first surface having been coated. Specifically, the surface to be supported during coating treatment, that is, the back surface, is a metal surface in the layer-on-layer coating device 1 and is a surface with a dried coated layer in the layer-on-layer coating device 2. The layer-on-layer coating device 1 and the layer-on-layer coating device 2 therefore use the feed rollers somewhat different in structure to feed the base sheet.

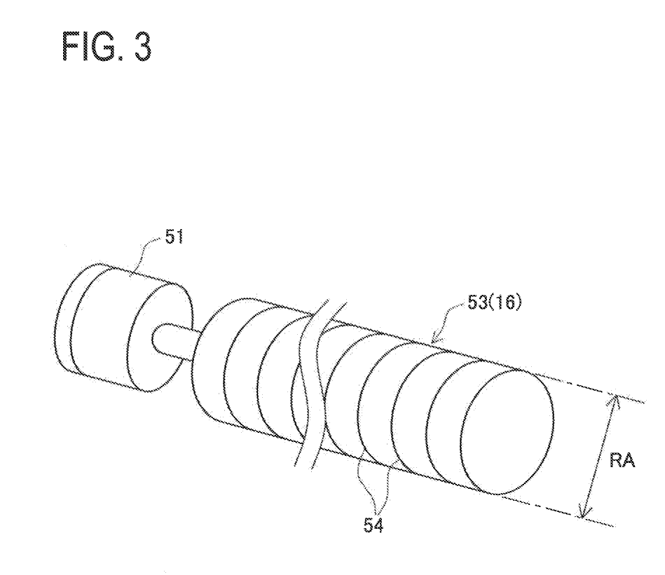

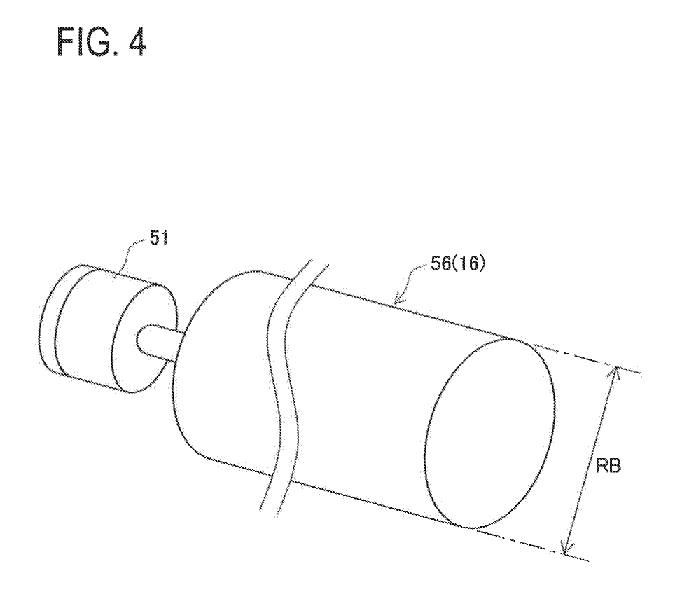

The layer-on-layer coating device 1 in the present embodiment includes a first feed roller 53 shown in FIG. 3 as the feed roller 16. The first feed roller 53 is formed, on its outer peripheral surface, with grooves 54 extending in a circumferential direction. The layer-on-layer coating device 2 includes a second feed roller 56 shown in FIG. 4 as the feed roller 16. The second feed roller 56 is not formed with any groove. The second feed roller 56 has a slightly larger diameter than that of the first feed roller 53. However, both of the feed rollers are remarkably smaller in diameter than the backup roll 41 of the die coating unit 15. Other parts excepting the feed rollers are the same in structure between the layer-on-layer coating devices 1 and 2.

In the present embodiment, a relationship between the diameter RA of the first feed roller 53, the diameter RB of the second feed roller 56, and the diameter RC of the backup roll 41 is expressed as below:

RA<RB<RC

For instance, for the backup roll 41 having a diameter of 250 mm, a roller having a diameter RA of about 30 mm is suitable as the first feed roller 53 and a roller having a diameter RB of about 100 mm is suitable as the second feed roller 56.

Meanwhile, in general, when such a strip-shaped member as the base sheet 10 is fed by winding around a roller-shaped member, air is likely to enter in a gap between the roller-shaped member and the strip-shaped member. It is therefore known that the strip-shaped member may float from the roller-shaped member. In this state, it is difficult to control a traveling state of the strip-shaped member by controlling rotation of the roller-shaped member. In this case, the floating height (distance) of the strip-shaped member from the roller-shaped member is called air-floating amount.

The air-floating amount is generally calculated by the following expression (I):

h=2.138×e⁻³×R×(V/T)^{2/3} (Ex. I)

where h: Air-floating amount (μm)

e: Base of natural logarithm

R: Radius of roller (mm)

V: Conveying speed (m/min

T: Conveying tension (N).

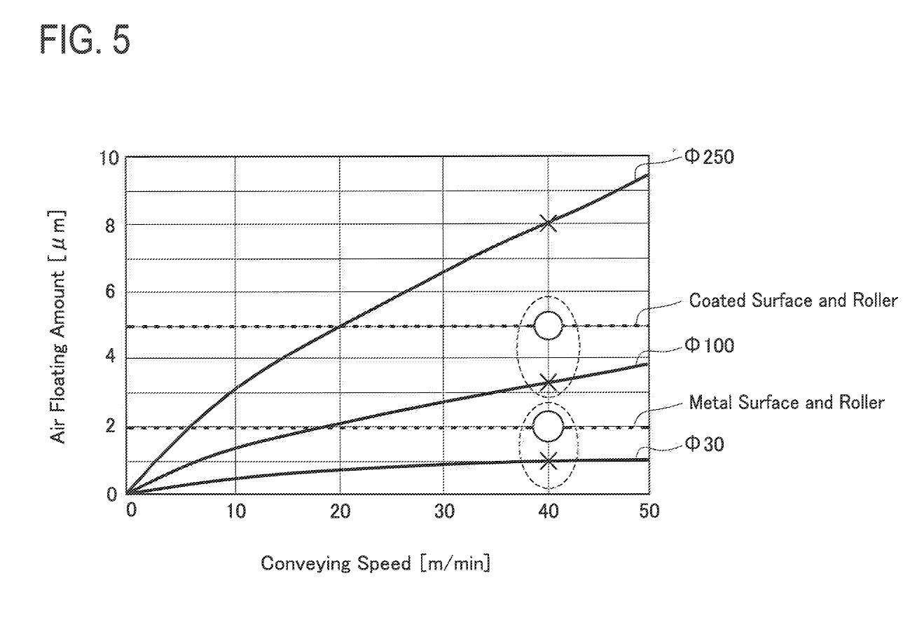

A relationship between the conveying speed and the air-floating amount of the strip-shaped member by the roller is shown by solid lines in FIG. 5. In this figure, the lateral axis indicates the conveying speed V (m/min) and the vertical axis indicates the air-floating amount h (μm). The air-floating amount h varies depending on the roller radius R as found in the above expression. Each curve in this figure is a graph showing the air-floating amount h in each case of the roller diameter is 30, 100, and 250 (mm) from lowest to highest. Those diameters correspond respectively to the diameter RA of the first feed roller 53, the diameter RB of the second feed roller 56, and the diameter RC of the backup roll 41 in the present embodiment.

In the layer-on-layer coating device 1 of the present embodiment, the conveying speed of the base sheet 10 is about 40 m/min. The air-floating amount of each roller at this conveying speed is given by reading the position of each mark × in FIG. 5 in the vertical axis. Specifically, the air-floating amount from the backup roll 41 (a 250-mm diameter) in the die coating unit 15 is about 8 μm. The air-floating amount from the first feed roller 53 having a diameter of 30 mm is about 1 μm. Further, the air-floating amount from the second feed roller 56 having a diameter of 100 mm is about 3.3 μm. In this graph, the conveying tension is constant at about 100 N.

On the other hand, to maintain the roller and the strip-shaped member in contact relation, the above air-floating amount needs to fall within a maximum distance between the roller and the strip-shaped member. The maximum distance between the roller and the strip-shaped member is expressed as the following expression II using respective surface roughness:

σ=√(A²+B²) (Ex. II)

where σ: Maximum distance

A, B: Surface roughness of each surface of the roller and the strip-shaped member facing each other. Specifically, to enable conveyance of the strip-shaped member by the roller, at least the relationship of σ>h has to be established.

In the present embodiment, it is a metal surface that faces the first feed roller 53 in the layer-on-layer coating device 1 and it is a surface of a coated layer having passed through drying and pressing processes that faces the surface facing the second feed roller 56 in the layer-on-layer coating device 2. Their surface roughness values are thus very different from each other. Accordingly, the maximum distances a are remarkably different between the layer-on-layer coating devices 1 and 2. The maximum distance a in the layer-on-layer coating device 1 is relatively very smaller than the maximum distance σ in the layer-on-layer coating device 2. For example, the maximum distance σ between the meal surface and a general roller is about 2 μm and the maximum distance σ between the coated layer surface and a general roller is about 5 μm.

Height corresponding to the maximum distances a between the base sheet 10 and the roller surface in the device of the present embodiment are indicated by broken lines in FIG. 5. Two marks ∘ in the figure represent intersection points of the broken lines with a line representing the conveying speed of about 40 m/min. On the other hand, the air-floating amount h at the backup roll 41 is as mentioned above about 8 μm (an uppermost mark × in the figure). Specifically, at this speed, the air-floating amount h is larger than the maximum distance σ in each case of the layer-on-layer coating devices 1 and 2. Thus, according to the backup roll 41 itself, at this speed, a reliable contact state of the backup roll 41 and the base sheet 10 is not ensured.

In the present embodiment, therefore, the feed roller 16 having a smaller diameter than the backup roll 41 is placed right behind the backup roll 41 (see FIG. 1). In the layer-on-layer coating device 1, including the first feed roller 53 having a diameter of 30 mm, the air-floating amount h from the first feed roller 53 is about 1 μm. On the other hand, the maximum distance a between the roller surface and the metal surface is about 2 μm. Accordingly, the air-floating amount h is smaller than the maximum distance σ. Thus, the first feed roller 53 can reliably feed forward the metal surface of the base sheet 10.

In the layer-on-layer coating device 2, including the second feed roller 56 having a diameter of 100 mm, the air-floating amount h from the second feed roller 56 is about 3.3 μm. On the other hand, the maximum distance a between the roller surface and the coated layer surface is about 5 μm. The air-floating amount h is thus smaller than the maximum distance σ. Accordingly, the second feed roller 56 can reliably feed forward the coated layer surface of the base sheet 10.

in FIG. 5, the corresponding air-floating amount h (mark ×) and maximum distance σ (mark ∘) are surrounded by a broken ellipse. If the feed roller 16 is absent, a position at which the tension can be controlled next to and downstream of the backup roll 41 is a place after the drying treatment. Since the drying treatment needs a certain degree of travel distance, this place is significantly apart from the backup roll 41. Accordingly, the tension control in such a place after completion of the drying treatment could not stabilize the tension of the base sheet 10 in the vicinity of the backup roll 41.

In the present embodiment, the first feed roller 53 in the layer-on-layer coating device 1 is formed with the circumferential grooves 54 on the outer periphery as shown in FIG. 3. The thus configured first feed roller 53 allows the air to release through the grooves 54 from the gap between the first feed roller 53 and the base sheet 10 to prevent floating of the base sheet 10. Accordingly, the air-floating amount h is further reduced as compared with the case using a roller not formed with the grooves 54.

Alternatively, the first feed roller may be a roller designed with high surface roughness by shot blast or other techniques, instead of the roller formed with the grooves 54. From the above expression II, the maximum distance a provided by the roller with high surface roughness is larger than the maximum distance a provided by the roller with low surface roughness. Thus, the roller with high surface roughness is able to convey the base sheet 10 stably. Furthermore, the first feed roller may be a roller with high surface roughness formed with the grooves 54.

In the layer-on-layer coating device 1, it is the metal surface that contacts with the first feed roller 53. Thus, even when the first feed roller 53 having the surface subjected to roughening treatment as above is used, it does not affect the base sheet 10. In the layer-on-layer coating device 2, on the other hand, is it not preferable to scratch an active material layer formed on the first surface. It is therefore preferable that the second feed roller 56 is not formed with any grooves and the like on the outer periphery. As the second feed roller 56, a feed roller treated to raise its surface roughness on purpose is not preferable.

As a factor to determine the diameter of the feed roller 16 (53, 56), it is also necessary to take into consideration allowable limits of an object to be conveyed with respect to bending. An object to be conveyed by the first feed roller 53 in the layer-on-layer coating device 1 is a metal foil coated with wet coated material. This object to be fed is soft and has a large allowable limit to bending. Thus, the small-diameter first feed roller 53 is usable. On the other hand, an object to be conveyed by the second feed roller 56 in the layer-on-layer coating device 2 is a foil applied with a coating layer having been dried. It is undesirable to sharply bend such a dried coating layer. Thus, in the layer-on-layer coating device 2, the diameter of the second feed roller 56 is determined to be as small as possible within an allowable range to bending of the dried active material layer. Accordingly, the second feed roller 56 has a larger diameter than that of the first feed roller 53.

According to the present embodiment, therefore, in both of the layer-on-layer coating devices 1 and 2, the base sheet 10 can be conveyed stably. This can produce a good electrode plate.

According to the layer-on-layer coating device 1 in the present embodiment explained in detail above, including the gravure coating unit 14 and the die coating unit 15, it is possible to form two-layer coating without performing drying treatment therebetween. Since the feed roller 16 is provided right behind the die coating unit 15, the base sheet 10 is stably conveyed by the feed roller 16. The feed roller 16 having a remarkably smaller diameter than that of the backup roll 41 enables stable conveyance even at a higher conveying speed at which feeding of the base sheet 10 by the backup roll 41 is apt to be unstable. The coating device for successively forming two layers without performing a drying process therebetween can stabilize the tension of the base sheet and perform stable coating of each layer. This consequently makes it possible to provide the coating device and the battery producing method capable of producing an electrode plate having stable performance.

The above embodiment is a mere example and does not impart any limitation to the invention. The present invention may be embodied in other specific forms without departing from the essential characteristics thereof. In the above embodiment, the gravure coating unit is used as the coating unit for first layer and the die coating unit is used as the coating unit for second layer. As an alternative, the coating unit for first layer may be not only the gravure coating unit but also any coating units. For example, a roller coating unit, a die coating unit, or others may be adopted as the coating unit for first layer as well as a gravure coating unit. On the other hand, the coating unit for second layer is not limited to the die coating unit but is limited to a device designed to perform coating in a non-contact manner between a coater and a base sheet.

For instance, the grooves formed in the feed roller used in the layer-on-layer coating device 1 are designed to extend separately in a circumferential direction, but may be formed of a spiral groove. In this case, the spiral groove is preferably made in a direction so that a contact position with the base sheet goes from the center to both ends as the roller is rotated.

### REFERENCE SIGNS LIST

1, 2 Layer-on-layer coating device
14 Gravure coating unit
15 Die coating unit
16, 53, 56 Feed roller
17 Drying device
41 Backup roll
42 Coater
51 Motor
54 Grooves
60 Double-side coating device
61 Drying and pressing device

1. A layer-on-layer coating device arranged to convey a strip-shaped base sheet in its longitudinal direction and apply two kinds of coating materials in layers to the base sheet, the device comprising:
a first coating unit to apply first coating material to one surface of the base sheet;
a second coating unit to apply second coating material in non-contact manner onto the first coating material coated on the one surface of the base sheet by the first coating unit without drying the first coated material by use of a drying furnace, and
a feed roller placed downstream of the second coating unit in a conveying direction of the base sheet, the feed roller being driven by a drive source, wherein
the second coating unit includes a backup roll placed to face a coater of the second coating material,
the feed roller has a smaller diameter than the backup roll, and
a winding angle of the base sheet on the feed roller is larger than a winding angle of the base sheet on the backup roll.

2. (canceled)

3. The layer-on-layer coating device according to claim 1, wherein the feed roller is formed, on its outer peripheral surface, with a plurality of grooves in a circumferential direction or with a spiral groove obliquely extending so that a facing position to the base sheet moves from inner toward outer in the axial direction as the rod is rotated.

4. The layer-on-layer coating device according to claim 1, wherein the feed roller has an outer peripheral surface with surface roughness higher than surface roughness of an outer peripheral surface of the backup roll.

5. A double-side coating device including two layer-on-layer coating devices according to claim 1, the double-side coating device being arranged to apply coating materials on each of surfaces of a strip-shaped base sheet in sequence to apply the coating materials to both of the surfaces of the base sheet,
wherein the double-side coating device comprises a drying device placed between the two layer-on-layer coating devices, and
the feed roller included in the layer-on-layer coating device to be used first has a smaller diameter than a diameter of the feed roller included in the layer-on-layer coating device to be used later.

6. A method for producing an electrode plate by conveying a strip-shaped base sheet in its longitudinal direction and applying two kinds of coating materials to the base sheet to form electrode active material layers, the method including:
applying first coating material containing binder to one surface of the base sheet;
applying second coating material containing electrode active material with a lower content of binder than that in the first coating material, in noncontact relation to the first coating material coated on the one surface of the base sheet without drying the first coated material by a drying furnace, and
conveying the base sheet by holding a back surface of a portion of the base sheet coated with the first and second coating materials in contact with the feed roller driven by a drive source,
wherein the feed roller has a smaller diameter than a diameter of a backup roll placed to face a coater of the second coating material, and
a winding angle of the base sheet on the feed roller is larger than a winding angle of the base sheet on the backup roll.

7. A method for producing a battery by using an electrode plate produced in such a manner that electrode active material layers are formed on both surfaces of a strip-shaped base sheet, the method includes:
applying first coating material containing binder to one surface of the base sheet;
applying second coating material containing electrode active material with a lower content of binder than that in the first coating material, in noncontact relation to the first coating material coated on the one surface of the base sheet without drying the first coated material by a drying furnace;
conveying the base sheet by making a back surface of a portion of the base sheet coated with the first and second coating materials by the first feed roller driven by a drive source;
drying the base sheet on which the first and second coating materials are coated;
applying first coating material containing binder to the other surface of the base sheet;
applying second coating material containing electrode active material with a lower content of binder than that in the first coating material, in noncontact relation to the first coating material coated on the other surface of the base sheet without drying the first coated material by a drying furnace;
conveying the base sheet by making a back surface of a portion of the base sheet coated with the first and second coating materials by a second feed roller driven by a drive source; and
drying the base sheet on which the first and second coating materials are coated,
the first feed roller having a smaller diameter than that of the second feed roller.

8. The double-side coating device according to claim 5, wherein the feed roller included in the layer-on-layer coating device to be used later has lower surface roughness than that of the feed roller included in the layer-on-layer coating device to be used first.

9. The double-side coating device according to claim 5, wherein the feed roller of at least one of the two layer-on-layer coating devices is formed, on its outer peripheral surface, with a plurality of grooves in a circumferential direction or with a spiral groove obliquely extending so that a facing position to the base sheet moves from inner toward outer in the axial direction as the rod is rotated.

10. The double-side coating device according to claim 5, wherein the feed roller of at least one of the two layer-on-layer coating devices has an outer peripheral surface with surface roughness higher than surface roughness of an outer peripheral surface of the backup roll.

11. The double-side coating device according to claim 9, wherein the feed roller of at least one of the two layer-on-layer coating devices has an outer peripheral surface with surface roughness higher than surface roughness of an outer peripheral surface of the backup roll.
